(19) United States
(12) Patent Application Publication
(10) Pub. No.: US 2005/0138425 A1
(43) Pub. Date: Jun. 23, 2005

(54) Method of analyzing network attack situation

(76) Inventors: Jin oh Kim, Daejeon-city (KR); Soo Hyung Lee, Daejeon-city (KR); Dongyoung Kim, Daejeon-city (KR); Beom Hwan Chang, Daejeon-city (KR); Jung Chan Na, Daejeon-city (KR); Sung Won Sohn, Daejeon-city (KR); Chee Hang Park, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/938,113

(22) Filed: Sep. 10, 2004

(30) Foreign Application Priority Data
Dec. 18, 2003 (KR) 2003-93100

(51) Int. Cl. H04L 9/00

(52) U.S. Cl. 713/201

(57) ABSTRACT

Provided is a method for analyzing a network attack situation. The method categorizes network intrusion detection alerts into network attack situations, counts the frequency of same-featured intrusion alert occurrence for each network attack situation using a counting algorithm based on time slots, and analyzes the network attack situation based on the frequency of same-featured intrusion detection alert occurrence, the rate of same-featured intrusion detection alert occurrence, or an AND/OR combination of them. The network attack situation can be correctly detected in real time without relatively being influenced by the size of the network or amount of the occurrence of the intrusion detection alerts.

### BACKGROUND OF THE INVENTION

This application claims the priority of Korean Patent Application No. 2003-93100, filed on Dec. 18, 2003, in the Korean Intellectual Property Office, the disclosure of which is incorporated herein in its entirety by reference.

1. Field of the Invention

The present invention relates to a method for analyzing network attack situations, and more particularly to a method for analyzing network attack situations, which analyzes real time multiple intrusion detection alerts that occur at multiple positions within a network.

2. Description of the Related Art

Detection of a network attack situation refers to tracing attack situations which occur within a network by analyzing the correlation between multiple intrusion detection alerts occurring at multiple positions within the network. For example, when multiple alerts occur for a specific host it is inferred that the specific host is under attack. Since such detection of the network attack situation reflects the current network attack situation, real time analysis is important.

However, previous methods of analyzing network attack situations were carried out in a form of database questionnaires and had limitations in analyzing the real time attack situation alerts within the network. For example, when an intrusion detection alert ‘A’ occurs, when using the data base questionnaire to determine how many times the intrusion detection alert ‘A’ has occurred within a certain time frame, a comparison of a large number of alerts has to be performed and the same process has to be performed on each alert resulting in a severe deterioration of performance.

Moreover, the alert correlation analysis process here contains to find alerts that have same characteristics, not to find just same intrusion detection alerts, and finding same-featured alerts requires severe comparison with old alerts whenever an intrusion detection alert occurs. In order to provide real time analysis, therefore, legacy methods such as data base questionnaire is not suitable.

### SUMMARY OF THE INVENTION

The present invention provides a method of analyzing a network attack situation, which accurately detects a network attack situation real time with being little influenced by a size of the network and the number of intrusion detection alerts.

The present invention also provides a computer readable recording medium in which a program for operation a method of analyzing a network attack situation in a computer is recorded that accurately detected a network attack situation real time with being little influence by a size of the network and the number of intrusion detection alerts.

According to an aspect of the present invention, there is provided a method for analyzing network attack situations which includes categorizing network intrusion detection alerts into predetermined attack situations, counting the frequency of same-featured intrusion detection alert occurrence for each network attack situation using a counting algorithm which is time slot based, and analyzing network attack situations based on the frequency of same-featured intrusion detection alert occurrence, the rate of same-featured intrusion detection alert occurrence, or an AND/OR combination of them.

Therefore a network attack situation can be accurately detected real time without being influenced by a size of the network and the number of intrusion detection alerts.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a categorization of network attack situations according to an embodiment of the present invention;

FIG. 2 illustrates a counting method using a counting algorithm based on time slots according to the present invention;

FIG. 3 illustrates an example of an operation of a time slot counter according to the present invention;

FIG. 4 illustrates a time slot counter algorithm; and

FIGS. 5 and 6 are flow charts illustrating a method of analyzing network attack situations according to an embodiment of the present invention.

### DETAILED DESCRIPTION OF THE INVENTION

The above and other features and advantages of the present invention will become more apparent by describing in detail exemplary embodiments thereof with reference to the attached drawings.

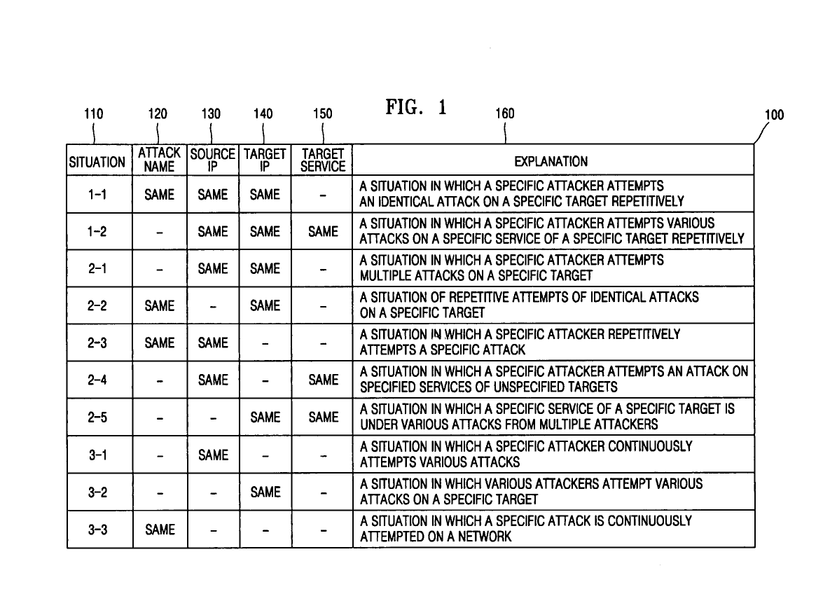

FIG. 1 illustrates a categorization of network attack situations according to an embodiment of the present invention.

The detection of the network attack situation through analysis of correlation among the intrusion detection alerts is used to infer the attack situation occurring in the network by measuring the frequency of occurrence of same-featured intrusion detection alerts within a predetermined period. The intrusion detection alerts include intrusion detection messages from security sensors and firewall logs.

Referring to FIG. 1, in order to perform correlation analysis of the intrusion detection alerts the intrusion detection alerts are categorized into groups which possess the same ten characteristics when combining the four features of an attack name 120, a source IP address 130, a target IP address 140, and a target service 150, which are items of the intrusion detection alert, and the groups which possess identical characteristics are each defined as a network attack situation. The target service is characterized with the combining a protocol type in layer 4 (that is, a protocol field of a IP header) and TCP/UDP target port number.

FIG. 1 illustrates ten different situations from 1-1 through 3-3 and each situation has identical characteristics. That is, situation 1-1 is defined as a specific attack A being carried out by a source S on a specific target D. In situation 1-1, thus, a train of a single attack from a source S to a target D is observed. In addition, situation 1-2 is defined as a specific service P of a specific target D is attacked by a source S.

Furthermore, situation 2-1 indicates a situation in which various kind of attacks are carried out on a specific target D by a source S, and situation 2-2 indicates a specific attack A carried out on a specific target D regardless of sources. Situation 2-3 indicates a situation in which a specific attack A is carried out by a source S, and situation 2-4 indicates a situation in which various kinds of attacks to a specific service P are carried out by a source S. Situation 2-5 indicates a situation in which a specific service P of a specific target D is attacked by multiple sources.

Situation 3-1 indicates a situation in which source S carries out various attacks, situation 3-2 indicates a situation in which a specific target D is attacked, and situation 3-3 indicates a situation in which a specific attack A is pervasively carried out in the network. From a security aspect such categorization of network attack situations and detection of network attack situations can be effectively used to analyze the current network situation. The categorization of network attack situations 100 illustrated in FIG. 1 is one embodiment of a network attack situation analysis and it is possible to categorize different attack situations.

The categorization of the network attack situations in the present invention is based on the observation of intrusion detection alerts which have identical characteristics(in other words, same-featured alerts), and the observations are made by measuring the frequency of occurrence of the intrusion detection alerts which have identical characteristics. A threshold value for effective network attack situation detection is used in the present invention.

Here is an example to clarify the overall analysis process. When an intrusion detection alert occurs, each situation is evaluated. To evaluate each situation, it is measured how many alerts that have same characteristics for the situation were there in a given time period. Then, the counting value is compared with the corresponding threshold to decide whether it violates the threshold value. For example, to evaluate the situation 1-1, the alerts that have same source, target, and attack name as features of the newly arrived one are counted because the situation 1-1 means how many alerts that have identical source, target, and attack name occurred in a given time period. And the counting value is compared with the threshold for the situation 1-1. Then, other situations are evaluated as the detailed evaluation procedure described later.

The threshold value constitutes the three steps of warning, declaration, and confirmation. That is, the situation in which the number of alerts which have identical characteristics exceeds a first threshold value is called a warning state, and the situation in which the number of alerts which have identical characteristics exceeds a second threshold value is a declaration state, and the situation in which the number of alerts which have identical characteristics exceed the third threshold value is called a confirmation state. Therefore, when applying a threshold value, the attack situation of the network is categorized into a total of 30 situations by a combination of three situations of a categorization of ten-network attack situations 1-1 through 3-3 and a threshold value illustrated in FIG. 1.

For example, in situation 1-1, depending on the situation in which the threshold value is violated the situation can be categorized into a 1-1 warning state, a 1-1 declaration state, or a 1-1 confirmation state. Therefore, in the present invention, 30 network attack situations are categorized and detected.

Each threshold value is set using the frequency of alert occurrence or the rate of occurrence of corresponding intrusion detection alerts among all of the detection alerts, or an AND/OR combination of the frequency of alert occurrence and the rate of occurrence of relevant alerts. The frequency of alert occurrence indicates how many times identical intrusion detection alerts occur within a given period. The rate of alert occurrence indicates the rate of the number of specific intrusion detection alerts among the number of the entire intrusion detection alerts in a given time period. The combination condition indicates the AND condition or OR condition for the frequency and rate of occurrence.

For example, in the AND condition, when both the frequency and rate of occurrence violates the threshold value it is considered a violation of threshold value. In the OR condition it is considered a violation of threshold value when either one of the frequency of occurrence or rate of occurrence violate the threshold value.

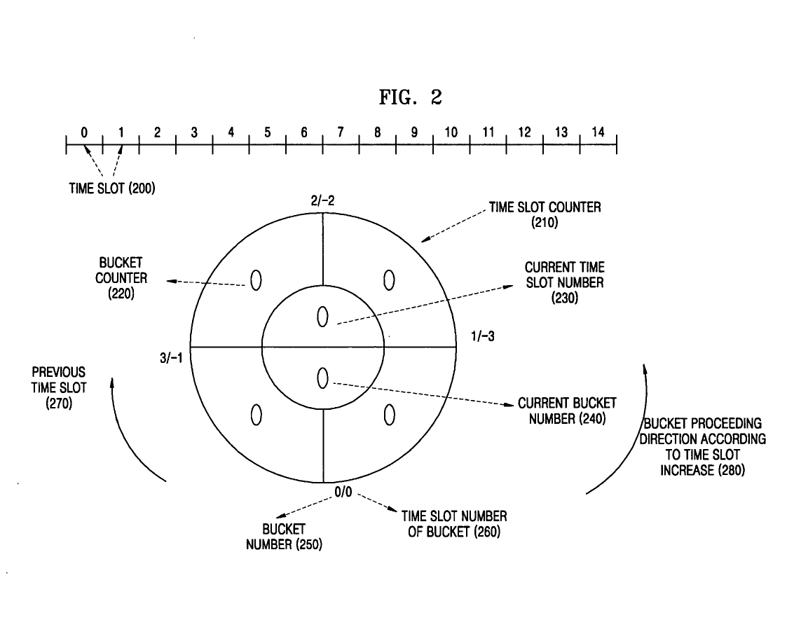

FIG. 2 illustrates a counting method using a counting algorithm based on time slots according to the present invention.

The present invention uses the counting algorithm based on time slots for counting intrusion detection alerts that occur within a given period. In order to perform real time detection of an attack situation, whenever an alert occurs, it is necessary to measure how many times same-featured alerts occured before the present alert. In addition, when performing such a measurement using the conventional database questionnaire method, the greater the number of intrusion detection alerts to be processed the greater deterioration in performance.

Therefore, the network attack analysis method according to the present invention maintains counters for an intrusion detection alert when it occurs, and uses a counting algorithm based on time slots which increases the value of the relevant counter when an identical intrusion detection alert occurs. A counter is newly created if the identical featured counter does not exist; otherwise, the existing one is used to count the same-featured alert.

When using a counter for identical intrusion detection alerts, a single-sized counter is used and the most simple method is to initialise the counter for each given period. For example, when applying a threshold value of the intrusion detection alert for an hour, the counter is initialised for every hour. Such a method is very convenient but lacks accuracy. In a situation in which the influence of the attack on the network is threatening enough to paralyse the network within several minutes to several tens of minutes, this method does not accurately reflect the attack situation of the network.

Therefore, the method of counting using time slots helps to improve such disadvantages. When counting using 60 time slots of a one minute interval the accuracy of the result in the previous example could be hugely improved.

For example, in a state in which the threshold value is 100, assuming that 50 alerts occurred in 59 minutes and 50 alerts occurred in 61 minutes, in reality enough alerts have occurred to violate the threshold value within two to three minutes. However, when using a one-hour counter, the information occurring in the 59^{th} minute is not reflected in the initialisation of the counter. Thus, such a crucial situation may not be detected. On the other hand, when operating 60 time slots in one-minute units, a more accurate result may be obtained. In the previous example, in the case in which 50 alerts occur in 61 minutes, the 60 time slots will record each 59-61 minutes of information in minutes, and it is determined whether the sum of intrusion detection alerts which have each been recorded in minutes exceeds the threshold value. In addition, such time slots obtain more accurate results as the time intervals of the slots become smaller. A counter based on time slots is used in the present invention to quickly and accurately count the intrusion detection alerts.

Referring to FIG. 2, the continuum of time is categorized into time slots 200. The duration of each time slot 200 is set beforehand by a user. A time slot counter 210 comprises a bucket counter 220, a current time slot number 230, and a current bucket number 240. The number of bucket counters 220 is obtained by dividing the analysis time interval by the number of time slot unit periods, and the number of buckets is called a window. The counter is maintained in each bucket 220 for identical detection alerts that occurred in identical time slots. The current time slot number 230 and the current bucket number 240 are the time slot number and bucket number of the most recently recorded intrusion detection alert.

For example, when the analysis time interval is one hour and the unit time of the time slots 200 is one minute, the size of the window is 60. That is, 60 buckets 220 exist in the time slot counter. In addition, when the current time slot number is 80 and identical intrusion detection alerts occur, the valid time slot number within the window would be 21-80 due to the size of the window (that is, the number of buckets within the analysis time, in this case 60). The current time slot number 230 recorded by the time slot counter 210 is 80.

The bucket number 250 increases in the counter clockwise direction 280. A time slot number of the bucket 260 decreases in the clockwise direction 270. In particular, the bucket corresponding to the current bucket number 240 recorded on the time slot counter 210 is related to the current time slot number 230, and the time slot number bucket 260 in arranged in the clockwise direction from the position of the current bucket. The time slot counter 210 does not include the bucket number 250 and the time slot number 260. Only each position of the bucket of the time slot counter 210 indicates the bucket number 250 and the time slot number 260.

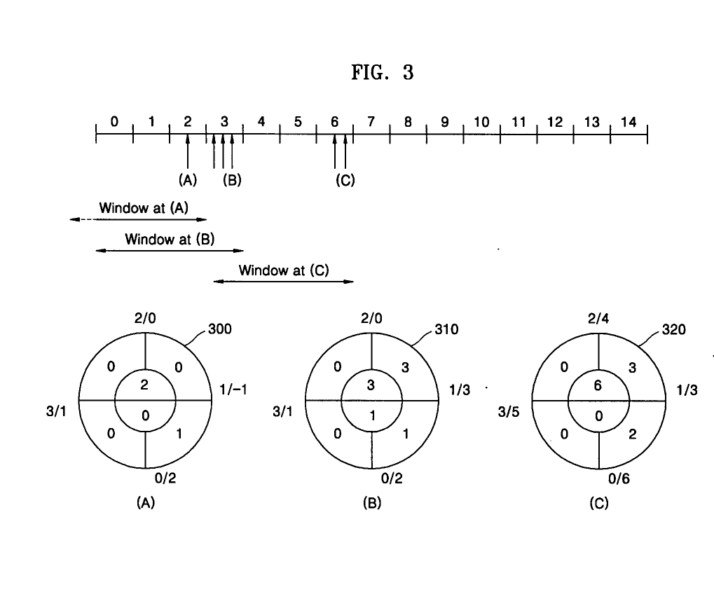

FIG. 3 illustrates an example of an operation of the timeslot counter according to the present invention.

Referring to FIG. 3, time slot counters A 300, B 310, and C 320 express a snapshot of the time slot counter at the relevant positions and the window size is four. When the first alert occurs at the (A) position it is recorded in the first bucket 300. In addition, the time slot number of the first alert that occurred at point (A), that is, 2, is recorded as the current time slot number. In the time slot counter the time slot number of the bucket decreases by one starting from 2 in the clockwise direction with respect to the current bucket.

In time slot 3 at point (B), three alerts occur and the time slot counter B 310 is in a counter state when the third alert occurs among these alerts. The current time slot number changes to 3, the bucket moves right, and the number 3 that occurs in slot 3 is recorded in bucket 1, and the current bucket number is recorded as 1. The time slot number of the window moves from slot—1-2 to 0-3 at point A. Therefore, the time slot number of bucket 1 is recorded as 3, and to the left the time slot numbers are 2, 1, and 0.

Two alerts occur in time slot 6 at point (C). Referring to the time slot counter C 320, in such a case, existing time slot number 0-3 is changed to time slot number 3-6 in the window. In addition, the current bucket number becomes 0, and 2 is recorded in bucket 0.

That is, the time slot counter of the present invention maintains the bucket for counting identical intrusion detection alerts occurring in each time slot, which are included within the window. The number of identical intrusion detection alerts that occur within the window is the same as the sum of all the buckets within the counter.

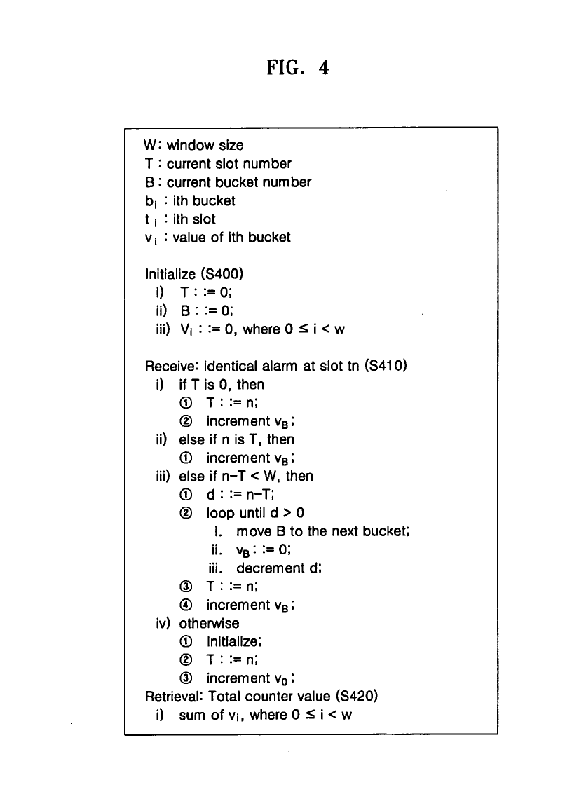

FIG. 4 illustrates a time slot counter algorithm in detail.

Referring to FIG. 4, W indicates the size of the window. In the time slot counter the current slot number is defined as T and the current bucket number is defined as B. The i^{th} slot is defined as tᵢ and the i^{th} bucket and value of a bucket are defined as bᵢ and vᵢ respectively. Initialise S400 indicates the initialising process and T, B, and all vᵢ are initialised to 0. When an alert occurs in the nth slot which is an arbitrary slot Receive S410 is performed.
i) When T is 0 this means that the present alert is the first alert since initialisation. Therefore T is changed to n and the value of v₀ is increased.
ii) When the previous alert occurs in the identical slot, n and T are identical. In such a case the value of V_{B} should be increased.
iii) When n-T is smaller than the window size W the alert arrives after an arbitrary delay but is still within the boundary of the window. In such a case, the information of the recent few slots are still valid, and other slot information is no longer valid. In this case, while moving for an amount of n-T, all slots are initialised to 0. When the move is completed, the V_{B} of the relevant bucket is increased.
iv) When the time difference between the previous alert and a newly occurring alert exceed the size of the window, the values of all bucket counters become useless. Therefore, after performing the initialising process again, T is changed to n and v₀ is increased. Furthermore, the time slot counter value of Retrieval S420 is a result of the sum of all the bucket values.

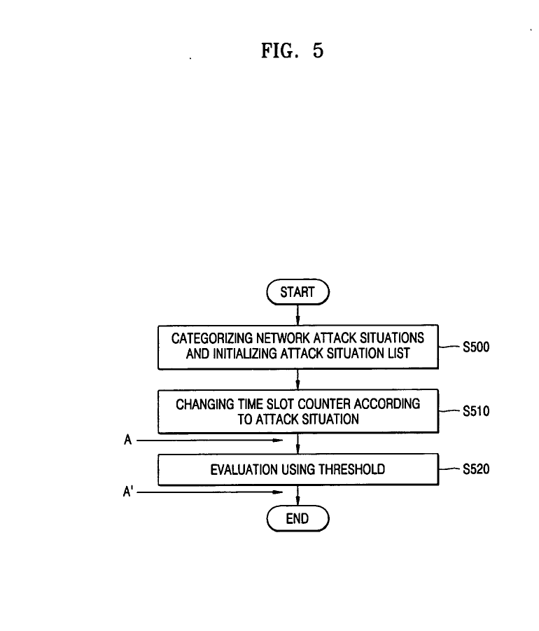

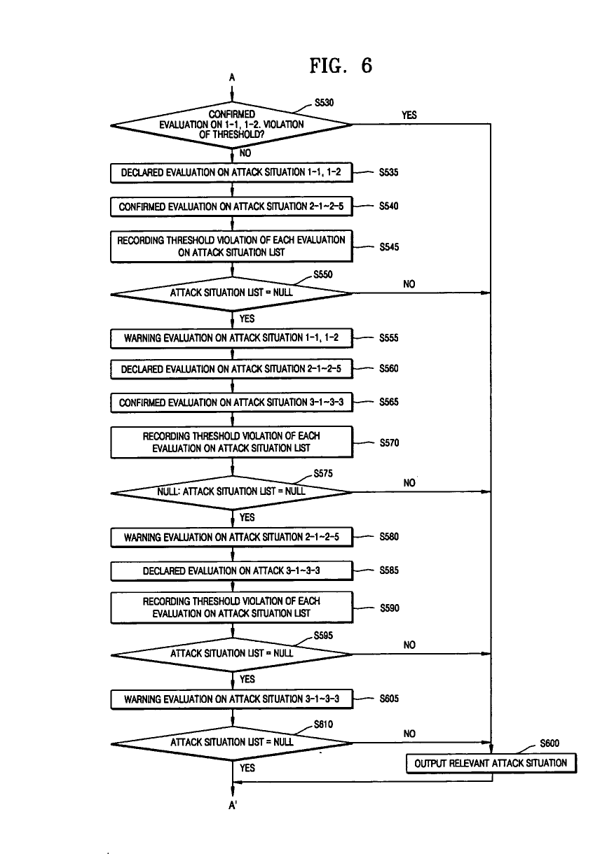

FIGS. 5 and 6 are flow charts of an embodiment of a method for analysing the network attack situations according to the present invention.

Referring to FIG. 5, to start the analysis of the network attack situations the network attack situations should be categorized and the attack situation list should be initialised S500. The attack situation list is a list for the attack situation categorization 100, which is illustrated in FIG. 1.

In the flowchart of the method for analysing the network attack situations according to the present invention, the input is a newly occurring intrusion detection alert while the output is the attack situation list, which is obtained due to threshold value violation. As described in FIG. 1, a threshold value is used to evaluate the attack situation and constitutes the three stages of warning, declaration, and confirmation. Eventually 30 attack situations are generated. That is, when it is attack situation 1-1, the evaluation is performed in the three stages of warning, declaration, and confirmation and is determined as a 1-1 warning, a 1-1 declaration, and a 1-1 confirmation accordingly.

After initialisation, whenever an intrusion detection alert occurs the time slot counter 210 is changed S510. In addition, the network attack situation 100 is evaluated S520 according to the intrusion detection alert using the threshold value. The evaluation of the network attack situation is described in detail in FIG. 6.

The change of the time slot counter 210 is performed through Receive S410 of the time slot counter algorithm illustrated in FIG. 4 and the evaluation of the threshold value is performed through the Retrieval S420 of the time slot counter algorithm illustrated in FIG. 4.

Time slot counters 210 exist for each network attack situation 100 in which intrusion detection alert occurs. Therefore, when the time slot counter 210 corresponding to the intrusion detection alert occurrence exists, the intrusion detection alert occurrence is recorded in the previous time slot counter 210, and when the time slot counter 210 does not exist a new time slot counter 210 is produced and performs counting according to the time slot counter algorithm.

The evaluation of the network attack situation using a threshold value will be described in detail referring to FIG. 6.

Referring to FIG. 6, first, an evaluation is carried out on the confirmed situation for situation 1-1 and 1-2 S530. When one situation violates either one of the two, the corresponding confirmation situation is output to an attack situation list and the evaluation is terminated S600.

When situation 1-1 and 1-2 are not confirmed situations S530, the declaration situation for situation 1-1 and 1-2 should be evaluated S535. When either one among the two violates the threshold value, the corresponding situation should be recorded on the attack situation list S545. In addition, the confirmation situation on situation 2-1 through 2-5 is evaluated S545 and when the threshold value is violated it is recorded S545 on the situation list. When the evaluation result attack situation list is not null S550, the corresponding attack situation is outputted and ended S600.

When the attack situation list is null the next step is evaluated. The warning situation of situation 1-1 and 1-2 are evaluated S555 and then the declaration situation of situation 2-1 through 2-5 are evaluated S560. In addition, the confirmation situations of situation 3-1 through 3-3 are evaluated S565. In such an evaluation process the situation in which the threshold value is violated is recorded S570 on the attack situation list and if the attack situation list is not null S575 it is outputted and ended S600.

When the attack situation list is null, the next steps are the evaluation S580 of the warning situation of situation 2-1 through 2-5, and the evaluation S590 process of the declaration situation for situation 3-1 through 3-3. As the same as described above, situations in which the threshold value is violated are recorded on the attack situation list and if the attack situation list is not null S595 it is outputted and ended S600.

Finally, the warning situations for situation 3-1 through 3-3 are evaluated S605. In the evaluation process if the threshold value is violated S610 the attack situation is outputted and ended S600.

The present invention can be realized as a code on a recording medium readable by a computer. The recording medium, which a computer can read includes all kinds of recording devices which store data that can be read by a computer system. ROM, RAM, CD-ROMs, magnetic tapes, hard disks, floppy disks, flash memory, and optical data storing devices are examples of the recording medium. The recording medium can also be in a carrier wave form (for example, transmission through the Internet). Furthermore, the recording medium can be accessed from a computer in a computer network, and the code can be stored and executed in a remote method.

According to the present invention, considering that the amount of data that has to be processed to analyse the network attack situation correlation using intrusion detection alerts can vary from tens of thousands of cases to millions of cases depending on the size of the network, by categorizing the intrusion detection alerts into various network attack situations and using a counting algorithm based on time slots, the network attack situation may be correctly detected real-time without being influenced by the size of the network or the amount of intrusion detection alerts.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for analyzing network attack situations comprising:
categorizing network intrusion detection alerts into predetermined attack situations;
counting the frequency of same-featured intrusion alert occurrence for each network attack situation using a counting algorithm which is time slot based; and
analyzing network attack situations based on the the frequency of same-featured intrusion detection alert occurrence, the rate of same-featured intrusion detection alert occurrence, or an AND/OR combination of them.

2. The method of claim 1, wherein categorizing includes categorizing the network intrusion detection alerts based on attack name, source IP address, target IP address, and target service information into each network attack situation.

3. The method of claim 1, wherein counting comprises:
preparing a number of buckets equal to the dividing the analysis time interval by time slot units;
sequentially recording the frequency of occurrence of the network attack situations occurring at each time slot in the bucket; and
summing the frequency of occurrence recorded in the bucket.

4. The method of claim 3, wherein the recording includes recording the frequency of occurrence from the start of the bucket after recording the frequency of occurrence at the end of the buckets which are arranged consecutively.

5. The method of claim 1, wherein analyzing includes analyzing and categorizing the network attack situations into the three stages of warning, declaration, and confirmation.

6. A computer readable recording medium in which a program for operating a method of analyzing network attack situations in a computer is recorded, the method comprising:
categorizing network intrusion detection alerts into predetermined network attack situations;
counting a frequency of same-featured intrusion detection alert occurrence for each network attack situation using a counting algorithm based on time slots; and
analyzing network attack situations based on the frequency of same-featured intrusion detection alert occurrence, the rate of same-featured intrusion detection alert occurrence, or an AND/OR combination of them.
